(19) United States
(12) Patent Application Publication
(10) Pub. No.: US 2009/0210471 A1
(43) Pub. Date: Aug. 20, 2009

(54) METHOD FOR TRANSFORMING DATA STREAM AND COMMUNICATION SYSTEM THEREOF

(75) Inventors: Yong-Ping Zheng, Shanghai (CN); Hua-Feng Mai, Shanghai (CN); Tony Tsai, Shanghai (TW)

Correspondence Address: J C PATENTS, INC., 4 VENTURE, SUITE 250, IRVINE, CA, 92618, US

(73) Assignee: INVENTEC APPLIANCES CORP., Taipei (TW)

(21) Appl. No.: 12/100,662

(22) Filed: Apr. 10, 2008

(30) Foreign Application Priority Data
Feb. 19, 2008 (TW) 97105785

(51) Int. Cl. G06F 17/14

(52) U.S. Cl. 708/400

(57) ABSTRACT

A method for transforming a data stream and a communication system thereof are provided. In a second communication terminal, a padding data of the data stream of a first communication terminal is checked whether it corresponds to a default value so as to determine whether a first bit order used for the data stream of the first communication terminal is consistent with a second bit order used for a data stream of the second communication terminal. When the padding data does not correspond to the default value, the data stream transmitted from the first communication terminal is transformed from the first bit order to the second bit order by the second communication terminal.

### CROSS-REFERENCE TO RELATED APPLICATION

This application claims the priority benefit of Taiwan application serial no. 97105785, filed on Feb. 19, 2008. The entirety the above-mentioned patent application is hereby incorporated by reference herein and made a part of specification.

### BACKGROUND OF THE INVENTION

1. Field of the Invention

The present invention generally relates to a communication system, in particular, to a method for transforming a data stream and a communication system thereof.

2. Description of Related Art

In recent years, along with the maturity of 3G wireless communication protocol, mobiles phone products using the 3G network to realize video telephony are put forward one after another. The video telephony is a newly developed application, and the communication protocol stack for the video telephony is still in its developing stage so far.

Currently, one of the main problems in the video telephony technology is the interoperability of video telephony from different manufacturers. Further, the capability of encoding/decoding supported multimedia audio and visual files, the compatibility, and the interoperability of video telephony protocol stacks developed by different manufacturers still need further improvement. In order to effectively solve the problem of the interoperability of video telephony, protocol stack development institutions have made a uniform and regulated standard at a protocol level, which then forms the international standard 3G-324M.

However, various modems for processing the 3G wireless communication use different data encoding methods for processing data streams transmitted therethrough. Therefore, it is difficult to process different protocol stacks, thus resulting in the failure of making a video call (video telephony).

### SUMMARY OF THE INVENTION

Accordingly, the present invention is directed to a method for transforming a data stream and a communication system thereof. When a data stream in a bit order different from the bit order of the terminal is received, this bit order is automatically transformed into the bit order of the terminal.

The present invention provides a method for transmitting a data stream, which includes the following steps. First, a first data stream is received. The first data stream contains padding data and the first data stream is encoded according to a first bit order. Then, the padding data is checked whether it corresponds to a default value. When the padding data does not correspond to the default value, the first data stream is transformed from the first bit order to a second bit order.

In an embodiment of the present invention, after the step of receiving the first data stream, the method further includes starting a data transmission thread to transmit a second data stream. After starting the data transmission thread, when the padding data of the first data stream does not correspond to the default value, the second data stream is transformed from the second bit order to the first bit order before being transmitted.

In an embodiment of the present invention, when the padding data does not correspond to the default value, the first data stream is transformed from the first bit order to the second bit order according to a transformation matrix.

In an embodiment of the present invention, before checking whether the padding data corresponds to the default value, the method further includes reading the padding data from the first data stream when the first data stream contains a padding mode flag, so as to check whether the padding data corresponds to the default value.

In an embodiment of the present invention, before the step of receiving the first data stream, the method further includes establishing a data channel, so as to receive the first data stream through the data channel.

The present invention provides a communication system, which includes a first communication terminal and a second communication terminal. The first communication terminal is used to send a first data stream. The first data stream contains padding data and is encoded according to a first bit order. The second communication terminal is used to receive the first data stream, and includes a data stream transformation module, for checking whether the padding data of the first data stream corresponds to a default value through the data stream transformation module, so as to transform the first data stream from the first bit order to a second bit order when the padding data does not correspond to the default value.

In an embodiment of the present invention, the second communication terminal further includes a data transmission thread, for transmitting a second data stream to the first communication terminal.

In an embodiment of the present invention, when the padding data of the first data stream does not correspond to the default value, the data stream transformation module may transform the second data stream from the second bit order to the first bit order, and then the second data stream is transmitted to the first communication terminal through the data transmission thread.

In an embodiment of the present invention, the first communication terminal and the second communication terminal use the 3G wireless communication protocol and the data stream transformation module uses the H.223 protocol in the 3G wireless communication protocol.

In the present invention, after receiving the first data stream transmitted by the first communication terminal, the second communication terminal determines whether the bit order of the first communication terminal is consistent with the bit order of the second communication terminal based on the padding data. If the bit orders are different, the second communication terminal transforms the first data stream to the bit order of the second communication terminal. In this manner, the problem of different encoding between the first communication terminal and the second communication terminal is overcome, thereby eliminating the difficulty in interoperability.

In order to make the aforementioned and other objects, features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a communication system according to an embodiment of the present invention.

FIG. 2 is a flow chart of a method for transforming a data stream according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

Generally speaking, in the course of communication, different modems used by various communication devices may use different bit orders for encoding data. For example, a calling terminal may use a bit order of “11001110,” while a called terminal may use a reverse bit order of “01110011.” Therefore, after the called terminal receives a data stream transmitted by the calling terminal, the subsequent protocol processing procedure cannot be executed. Thus, the present invention provides a method for transforming a data stream and a communication system thereof, so as to solve the conventional encoding problem. In order to make the contents of the present invention more apparent, the present invention is described in detail in the following embodiments.

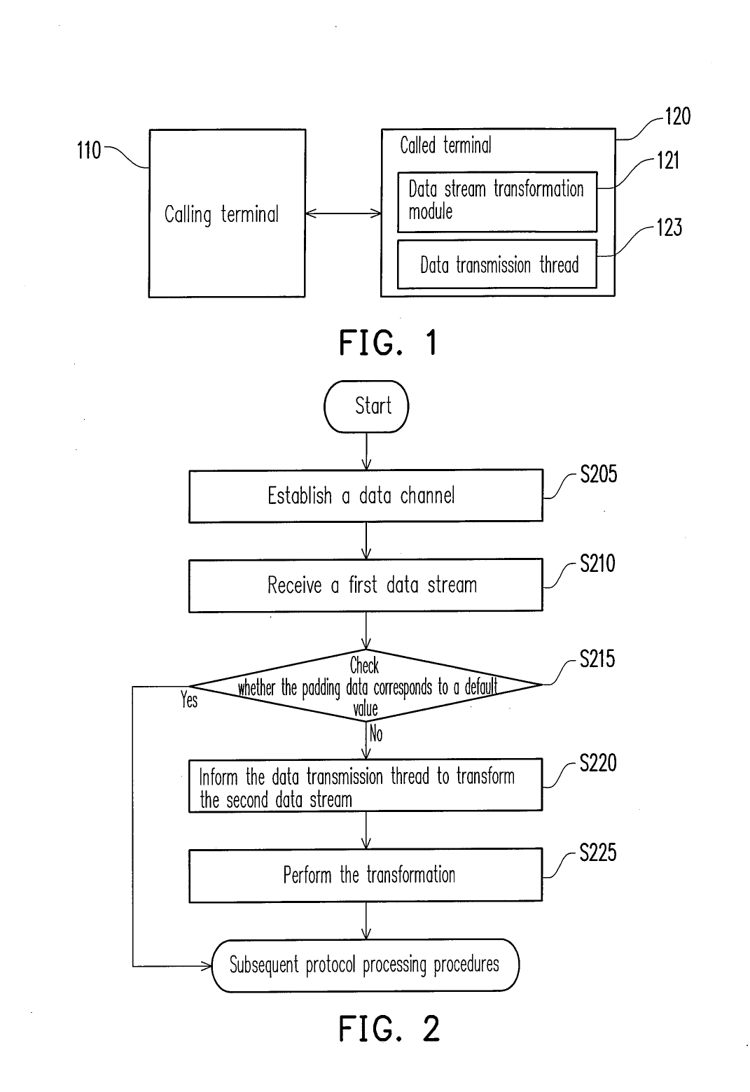

FIG. 1 is a block diagram of a communication system according to an embodiment of the present invention. Referring to FIG. 1, the system includes a calling terminal 110 and a called terminal 120. The calling terminal 110 is used to send a first data stream to the called terminal 120, and the first data stream contains a padding data and is encoded according to a first bit order.

The called terminal 120 includes a data stream transformation module 121 and a data transmission thread 123. The data stream transformation module 121 checks whether the padding data of the first data stream corresponds to a default value, so as to transform the first data stream from the first bit order to a second bit order when the padding data does not correspond to the default value. The data transmission thread 123 is used to transmit a second data stream to the calling terminal 110. If the calling terminal 110 and the called terminal 120 adopt different bit orders, the padding data in the calling terminal 110 and the called terminal 120 are different. Therefore, the data stream transformation module 121 may determine whether the bit orders of the two terminals are consistent according to the padding data.

In this embodiment, the padding data of the called terminal 120 is encoded according to, for example, the second bit order, and the default value (for example, the padding data used by the called terminal 120) in the called terminal 120 corresponds to the second bit order. Therefore, the called terminal 120 can determine whether the bit order of the first data stream sent by the calling terminal 110 is consistent with the bit order of the called terminal 120 according to the default value.

Further, the padding data is transmitted between the calling terminal 110 and the called terminal 120 when no audio, video, and control data needs to be transmitted therebetween. For example, in the 3G-324M protocol, as far as the level 2 of a multiplex layer (“MUX 2” for short hereinafter) of the H.223 protocol is concerned, the padding data, for example, begins with “E1 4D 00 00 00,” which is only an example for illustration, and other protocol layers may have their corresponding padding data.

The calling terminal 110 and the called terminal 120 use, for example, the 3G wireless communication protocol. The data stream transformation module 121 uses, for example, the H.223 protocol in the 3G wireless communication protocol.

The steps of the method for transforming a data stream will be described with the above system. FIG. 2 is a flow chart of the method of transforming a data stream according to an embodiment of the present invention. Referring to FIGS. 1 and 2, in Step S205, first, a data channel is established between the calling terminal 110 and the called terminal 120, such that the calling terminal 110 sends the first data stream to the called terminal 120 through the data channel. Then, in Step S210, the called terminal 120 begins monitoring to the data channel to receive the first data stream. The first data stream sent by the calling terminal 110 may contain a padding data, and the first data stream is encoded according to the first bit order. Upon the data channel is established, the called terminal 120 starts the data transmission thread 123 to get ready to transmit the second data stream.

Thereafter, as shown in Step S215, the called terminal 120 checks whether the padding data of the first data stream corresponds to a default value by the use of the data stream transformation module 121. That is to say, through checking whether the padding data corresponds to a default value, it is determined that whether the bit orders of the two terminals are consistent. If the padding data in the first data stream corresponds to the default value, the subsequent protocol processing procedure may be executed. If the padding data in the first data stream does not correspond to the default value, Step S220 is performed.

For example, after a 64K data channel for video telephony is established between the calling terminal 120 and the called terminal 120 through the 3 G wireless network, the video telephony protocols of the two terminals begin sending information such as handshake. Headers of protocol data units (PDU) containing information such as handshake all include a large amount of constant padding data.

Before checking whether the padding data corresponds to the default value, the called terminal 120 reads the padding data when the received first data stream contains a padding mode flag, so as to determine whether the padding data corresponds to the default value. For the MUX 2 of the H.223 protocol, when no audio, video, and control data needs to be transmitted in the course of the video telephony, the multiplexer of the calling terminal 110 will add a padding mode flag after the header of the protocol data unit. Thus, the data stream transformation module 121 reads the padding data in the first data stream through checking the padding mode flag.

It is assumed that the padding data of the called terminal 120 is “E1 4D 00 00 00” (i.e., the default value in the called terminal 120). When the called terminal 120 receives the first data stream transmitted by the calling terminal 110, the data stream transformation module 121 checks whether the padding in the first data stream is consistent with “E1 4D 00 00 00.” If the padding data in the first data stream contains a plurality of “E1 4D 00 00 00,” it indicates that the first bit order of the first data stream is consistent with the second bit order of the called terminal 120, and the transformation is not required at this time. On the contrary, if the padding data contains a plurality of “87 B2 00 00 00,” it is determined that the data will not be processed by the called terminal until the bit order of the calling terminal 110 is transformed.

Then, in Step S220, when the data stream transformation module 121 determines that the padding data in the received first data stream does not correspond to the default value, the data transmission thread 123 is informed to transform the second data stream. That is to say, when the padding data in the first data stream does not correspond to the default value of the called terminal 120, not only the received first data stream needs the code transformation, but also the second data stream to be sent by the called terminal 120 to the calling terminal 110 needs to be transformed from the second bit order to the first bit order before being transmitted.

Finally, in Step S225, the data stream transformation module 121 performs code transformation so as to transform the first data stream from the first bit order to the second bit order. In addition, after the called terminal 120 starts the data transmission thread 123, when the padding data of the first data stream does not correspond to the default value, the second data stream is transformed from the second bit order to the first bit order by the data stream transformation module 121 before being transmitted.

In this embodiment, when the padding data does not correspond to the default value, according to a transformation matrix (for example, a commonly used matrix “REVERSEBITS,” or a matrix defined by developers), the first data stream is transformed from the first bit order to the second bit order, and the second data stream is transformed from the second bit order to the first bit order.

The protocol stack of 3G-324M will be illustrated hereinafter. The 3G-324M is a composite protocol mainly including the H.324, the H.245, and the H.223 protocols. Each part is responsible for a specific function. For example, the H.223 protocol is mainly responsible for multiplexing, demultiplexing, and error processing of the data stream. The H.245 protocol is mainly responsible for controlling the processing of messages.

In this embodiment, a data stream transformation layer may be added before the multiplex/demultiplex layer of the H.223 protocol, for processing the code transformation. The function of automatically transforming a data stream is added to the 3G-324M protocol, for effectively transforming the data streams of different bit orders sent by various 3G modems, so as to ensure the correct processing of the data streams according to the following protocols of 3 G-324M.

In view of the above, through the methods in the aforementioned embodiments, in the called terminal, the first data stream can be transformed from the first bit order to the second bit order of the called terminal. The second data stream before being transmitted may be transformed from the second bit order to the first bit order so as to be consistent with the first bit order adopted by the calling terminal. Accordingly, the automatic code determination and transformation are completed, thereby eliminating the problem of the difficulty in interoperability caused by different encoding between the calling terminal and the called terminal and further ensuring the success of the handshake of video telephony and transmission of multimedia data streams.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for transforming a data stream, comprising:
receiving a first data stream, wherein the first data stream contains a padding data and is encoded according to a first bit order;
checking whether the padding data corresponds to a default value; and
when the padding data does not correspond to the default value, transforming the first data stream from the first bit order to a second bit order.

2. The method for transforming a data stream according to claim 1, wherein after the step of receiving the first data stream, further comprising:
starting a data transmission thread to transmit a second data stream.

3. The method for transforming a data stream according to claim 2, wherein after the step of starting the data transmission thread, further comprising:
when the padding data of the first data stream does not correspond to the default value, transforming the second data stream from the second bit order to the first bit order before transmitting the second data stream.

4. The method for transforming a data stream according to claim 1, wherein the step of transforming the first data stream from the first bit order to the second bit order comprises:
transforming the first data stream from the first bit order to the second bit order according to a transformation matrix.

5. The method for transforming a data stream according to claim 1, before checking whether the padding data corresponds to the default value, further comprising:
when the first data stream contains a padding mode flag, reading the padding data to check whether the padding data corresponds to the default value.

6. The method for transforming a data stream according to claim 1, before receiving the first data stream, further comprising:
establishing a data channel to receive the first data stream through the data channel.

7. A communication system, comprising:
a first communication terminal, for sending a first data stream, wherein the first data stream contains a padding data and is encoded according to a first bit order; and
a second communication terminal, for receiving the first data stream, wherein the second communication terminal comprises a data stream transformation module, for checking whether the padding data of the first data stream corresponds to a default value, so as to transform the first data stream from the first bit order to a second bit order when the padding data does not correspond to the default value.

8. The communication system according to claim 7, wherein the second communication terminal further comprises:
a data transmission thread, for transmitting a second data stream to the first communication terminal.

9. The communication system according to claim 8, wherein the data stream transformation module further transforms the second data stream from the second bit order to the first bit order when the padding data of the first data stream does not correspond to the default value, and then the second data stream is transmitted to the first communication terminal through the data transmission thread.

10. The communication system according to claim 8, wherein the first communication terminal and the second communication terminal adopt a 3G wireless communication protocol.

11. The communication system according to claim 10, wherein the data stream transformation module adopts an H.223 protocol in the 3 G wireless communication protocol.
